(19) United States
(12) Patent Application Publication
(10) Pub. No.: US 2026/0351480 A1
(43) Pub. Date: Nov. 5, 2026

(54) MULTILAYER CERAMIC CAPACITOR

(71) Applicant: Murata Manufacturing Co., Ltd., Nagaokakyo-shi (JP)

(72) Inventor: Tetsuhisa MATSUMOTO, Nagaokakyo-shi (JP)

(21) Appl. No.: 19/712,684

(22) Filed: Jun. 18, 2026

Related U.S. Application Data
(63) Continuation of application No. PCT/JP2024/039382, filed on Nov. 6, 2024.

(30) Foreign Application Priority Data
Dec. 22, 2023 (JP) 2023-217185

(51) Int. Cl. H01G 4/30; H01G 4/012; H01G 4/232

(52) U.S. Cl. CPC H01G 4/30; H01G 4/012; H01G 4/232

(57) ABSTRACT

In a multilayer ceramic capacitor, each of first through fourth internal electrodes include a body portion and an extended portion extending to a corresponding end surface, a first connection-side end portion of a first extended portion extending toward a side of a first end surface in the first internal electrode and a third connection-side end portion of a third extended portion extending toward the side of the first end surface in the third internal electrode do not overlap with each other in a lamination direction, and a second connection-side end portion of a second extended portion extending toward a side of a second end surface in the second internal electrode and a fourth connection-side end portion of a fourth extended portion extended toward the side of the second end surface in the fourth internal electrode do not overlap with each other in the lamination direction.

### CROSS REFERENCE TO RELATED APPLICATIONS

This application claims the benefit of priority to Japanese Patent Application No. 2023-217185 filed on Dec. 22, 2023 and is a Continuation Application of PCT Application No. PCT/JP2024/039382 filed on Nov. 6, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

A multilayer ceramic capacitor is, for example, configured to include a plurality of laminated dielectric layers and a plurality of internal electrodes laminated on the dielectric layers and include outer electrodes electrically connected to the internal electrodes. In particular, regarding the shape of the internal electrode, internal electrodes having various shapes have been disclosed in recent years with a growing demand for smaller and higher-capacitance multilayer ceramic capacitors.

However, generally, internal electrode end portions overlap in the lamination direction, and, when viewed in a cross section taken along the length direction and lamination direction, including the internal electrode end portions, the number of overlapping internal electrodes abruptly decreases from the central side of a multilayer body toward an end surface side (Japanese Unexamined Patent Application Publication No. 2018-093165).

### SUMMARY OF THE INVENTION

Thus, in an existing product in which the number of overlapping internal electrodes abruptly decreases from the central side of the multilayer body toward the end surface side, during pressure bonding, the dielectric layers (outer layer sheets and inner layer sheets) in the vicinity of the internal electrode end portions undergo abrupt flow and elongation, resulting in a state where the dielectric layers are tensioned, so, in some cases, the dielectric layers in the vicinity of the internal electrode end portions cannot be bonded so as to conform to the shape of the overlapping internal electrode end portions.

As a result, the adhesion during pressure bonding at the interfaces between the outer layer portion, the dielectric layers, and the internal electrodes decreases, so, in some cases, voids occur therebetween and delamination starting from these voids occurs.

Example embodiments of the present invention provide multilayer ceramic capacitors in each of which the likelihood of occurrence of delamination at an interfaces between an outer layer portion, dielectric layers, and internal electrodes is reduced.

A multilayer ceramic capacitor according to an example embodiment of the present invention includes a multilayer body including a plurality of dielectric layers and a plurality of internal electrodes that are alternately laminated with each other, a first main surface and a second main surface opposite to each other in a lamination direction, a first side surface and a second side surface opposite to each other in a width direction orthogonal to the lamination direction, and a first end surface and a second end surface opposite to each other in a length direction orthogonal to the lamination direction and the width direction, a first outer electrode on the first end surface, and a second outer electrode on the second end surface, wherein the internal electrodes include a first internal electrode, a second internal electrode, a third internal electrode, and a fourth internal electrode that are on different planes, the first internal electrode includes a first body portion having a substantially rectangular shape or having a substantially rectangular shape with a cutout on a side of the first end surface, and a first extended portion coupled to the first body portion, the first extended portion having a dimension in the width direction smaller than a dimension of the first body portion in the width direction, the first extended portion being extended to the first end surface, the first body portion includes a first non-connection-side end portion located on a side of the second end surface, and a first connection-side end portion located on the side of the first end surface, the second internal electrode includes a second body portion having a substantially rectangular shape or having a substantially rectangular shape with a cutout on the side of the second end surface, and a second extended portion coupled to the second body portion, the second extended portion having a dimension in the width direction smaller than a dimension of the second body portion in the width direction, the second extended portion being extended to the second end surface, the second body portion includes a second non-connection-side end portion located on the side of the first end surface, and a second connection-side end portion located on the side of the second end surface, the third internal electrode includes a third body portion having a substantially rectangular shape or having a substantially rectangular shape with a cutout on the side of the first end surface, and a third extended portion coupled to the third body portion, the third extended portion having a dimension in the width direction smaller than a dimension of the third body portion in the width direction, the third extended portion being extended to the first end surface, the third body portion includes a third non-connection-side end portion located on the side of the second end surface, and a third connection-side end portion located on the side of the first end surface, the fourth internal electrode includes a fourth body portion having a substantially rectangular shape or having a substantially rectangular shape with a cutout on the side of the second end surface, and a fourth extended portion coupled to the fourth body portion, the fourth extended portion having a dimension in the width direction smaller than a dimension of the fourth body portion in the width direction, the fourth extended portion being extended to the second end surface, the fourth body portion includes a fourth non-connection-side end portion located on the side of the first end surface, and a fourth connection-side end portion located on the side of the second end surface, the first connection-side end portion and the third connection-side end portion do not overlap with each other in the lamination direction, and the second connection-side end portion and the fourth connection-side end portion do not overlap with each other in the lamination direction.

According to example embodiments of the present invention, it is possible to provide multilayer ceramic capacitors in each of which the likelihood of occurrence of delamination at the interfaces between an outer layer portion, dielectric layers, and internal electrodes is reduced.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1.

FIG. 2 is a diagram that shows internal electrodes 15 disposed within a multilayer body 2.

FIG. 3 is a cross-sectional view taken along the line III-III in FIG. 1.

FIG. 4 is a cross-sectional view taken along the line IV-IV in FIG. 1.

FIG. 5 is a cross-sectional view of an existing multilayer ceramic capacitor 100, corresponding to FIG. 4.

FIGS. 6A and 6B show diagrams that illustrate a first modification of the internal electrode 15.

FIGS. 7A and 7B show diagrams that illustrate a second modification of the internal electrode 15.

FIGS. 8A and 8B show diagrams that illustrate third and fourth modifications of the internal electrode 15.

FIG. 9 is a diagram that shows an eighth modification of the internal electrode 15.

FIG. 10 is a diagram that shows a ninth modification of the internal electrode 15.

FIG. 11 is a table that shows the dimensions of body portions of the internal electrodes of the multilayer ceramic capacitor 1 of Example 1.

FIG. 12 is a table that shows the dimensions of extended portions of the internal electrodes of the multilayer ceramic capacitor 1 of Example 1.

FIG. 13 is a table that shows the dimensions of body portions of the internal electrodes of the multilayer ceramic capacitor 1 of Example 2.

FIG. 14 is a table that shows the dimensions of extended portions of the internal electrodes of the multilayer ceramic capacitor 1 of Example 2.

FIG. 15 shows confirmation results of defects due to delamination in Comparative Example 1, Example 1, and Example 2.

### DETAILED DESCRIPTION OF THE EXAMPLE EMBODIMENTS

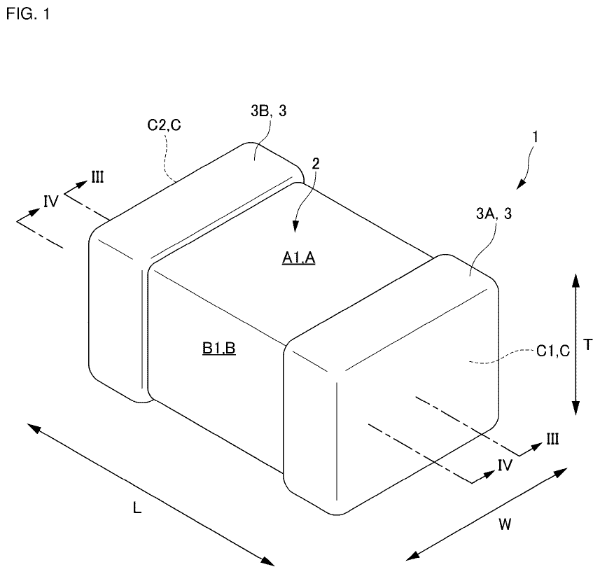

Hereinafter, multilayer ceramic capacitors according to example embodiments of the present invention will be described. FIG. 1 is a schematic perspective view of the multilayer ceramic capacitor 1.

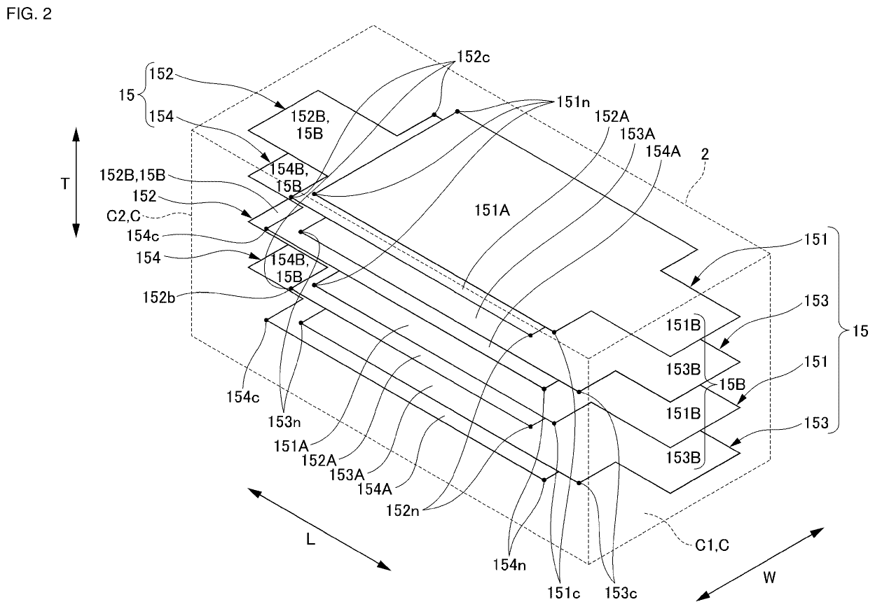

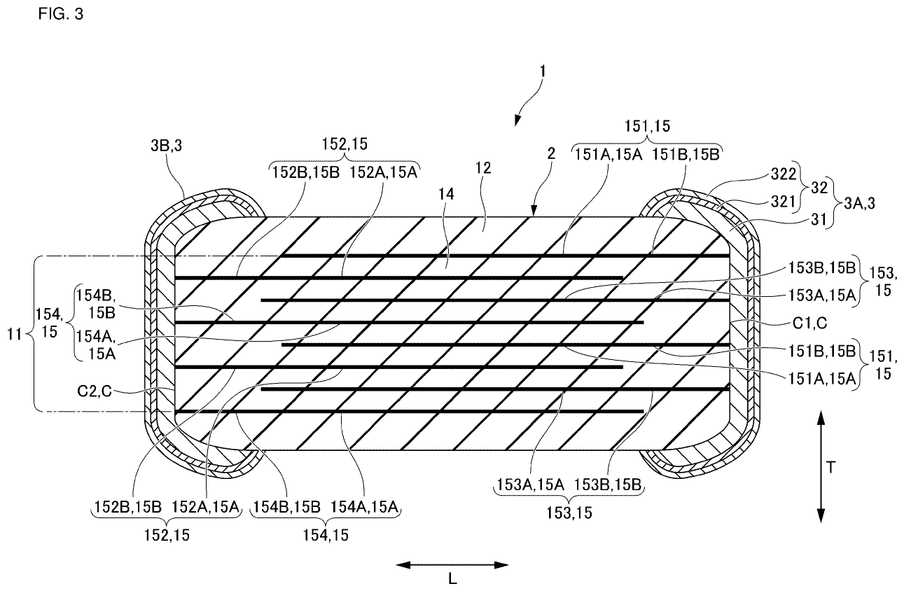

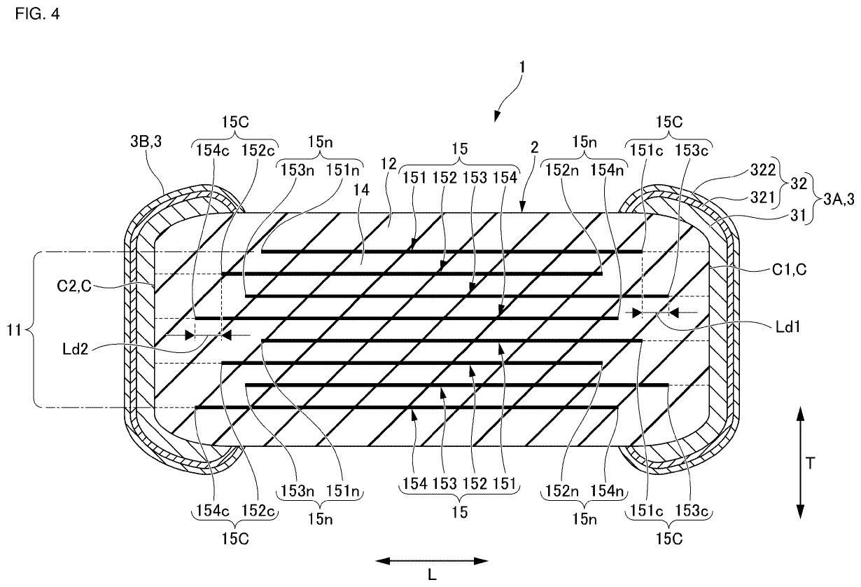

The multilayer ceramic capacitor 1 has a substantially rectangular shape, and includes a multilayer body 2 and a pair of outer electrodes 3 respectively provided at both ends of the multilayer body 2. FIG. 2 is a diagram that shows internal electrodes 15 disposed within the multilayer body 2. FIG. 3 is a cross-sectional view taken along the line III-III in FIG. 1. FIG. 4 is a cross-sectional view taken along the line IV-IV in FIG. 1.

The multilayer body 2 includes an inner layer portion 11 and outer layer portions 12. In the inner layer portion 11, a plurality of dielectric layers 14 and a plurality of the internal electrodes 15 are laminated.

In the following description, as terms representing the orientation of the multilayer ceramic capacitor 1, in the multilayer ceramic capacitor 1, a direction in which the pair of outer electrodes 3 is provided is defined as a length direction L. A direction in which the dielectric layers 14 and the internal electrodes 15 are laminated is referred to as a lamination direction T. A direction that intersects both the length direction L and the lamination direction T is defined as a width direction W. In the present example embodiment, the width direction W is orthogonal to both the length direction L and the lamination direction T.

In the following description, among the six outer peripheral surfaces of the multilayer body 2 shown in FIG. 2, a pair of outer peripheral surfaces that are opposite in the lamination direction T is referred to as a first main surface A1 and a second main surface A2, and, when it is not necessary to distinguish between the first main surface A1 and the second main surface A2, the first main surface A1 and the second main surface A2 are collectively referred to as a main surface A. A pair of outer peripheral surfaces that are opposite in the width direction W is referred to as a first side surface B1 and a second side surface B2, and, when it is not necessary to distinguish between the first side surface B1 and the second side surface B2, the first side surface B1 and the second side surface B2 are collectively referred to as a side surface B. A pair of outer peripheral surfaces that are opposite in the length direction L is referred to as a first end surface C1 and a second end surface C2, and, when it is not necessary to distinguish between the first end surface C1 and the second end surface C2, the first end surface C1 and the second end surface C2 are collectively referred to as an end surface C.

The multilayer ceramic capacitor 1 that includes the multilayer body 2 and the outer electrodes 3 preferably has a dimension in the length direction L larger than or equal to about 0.2 mm and smaller than or equal to about 5.7 mm, a dimension in the lamination direction T larger than or equal to about 0.1 mm and smaller than or equal to about 2.7 mm, and a dimension in the width direction W larger than or equal to about 0.1 mm and smaller than or equal to about 5.0 mm, for example.

The multilayer body 2 has a substantially rectangular shape, and corner portions and ridge portions are preferably rounded. The corner portion refers to a portion where three sides of the multilayer body 2 intersect, and the ridge portion refers to a portion where two sides of the multilayer body 2 intersect. One or some or all of the main surfaces A, the side surfaces B, and end surfaces C may have unevenness or the like formed.

The dielectric layers 14 are made of, for example, a ceramic material. For example, a dielectric ceramic made of main components, such as BaTiO₃, CaTiO₃, SrTiO₃, and CaZrO₃, can be used as a ceramic material. A secondary component having a lower content than a main component, such as an Mn compound, an Fe compound, a Cr compound, a Co compound, and an Ni compound, may be added to these main components according to the desired characteristics of the multilayer body.

The thickness of the dielectric layer 14 is preferably greater than or equal to about 0.5 μm and less than or equal to about 10 μm, for example. The number of dielectric layers 14, including the outer layer portions 12, is preferably greater than or equal to 15 and less than or equal to 700, for example.

The internal electrode 15 has substantially rectangular parallelepiped body portion 15A, and an extended portion 15B extending from the body portion 15A to one end surface C and connected to the outer electrode. In the present example embodiment, the dimension, in the width direction W, of a portion (connecting portion) of the extended portion 15B, exposed at the end surface C, is smaller than the dimension in the width direction W of the body portion 15A.

The internal electrodes 15 of the present example embodiment include a plurality of sets of a first internal electrode 151, a second internal electrode 152, a third internal electrode 153, and a fourth internal electrode 154 that are laminated with the dielectric layers 14 interposed therebetween. Hereinafter, when it is not necessary to distinguish among the first internal electrode 151, the second internal electrode 152, the third internal electrode 153, and the fourth internal electrode 154, the first internal electrode 151, the second internal electrode 152, the third internal electrode 153, and the fourth internal electrode 154 are collectively referred to as an internal electrode 15.

The internal electrode 15 may be made of a suitable conductive material, for example, a metal such as Ni, Cu, Ag, Pd, and Au, or an alloy that includes at least one of these metals, such as Ag—Pd alloy.

The thickness of the internal electrode 15 is preferably, for example, greater than or equal to about 0.2 μm and less than or equal to about 2.0 μm, for example. The number of internal electrodes 15 is preferably greater than or equal to 15 and less than or equal to 200 in total, for example.

In the multilayer body 2, major portions of the body portions 15A of adjacent internal electrodes 15 overlap and face each other in the lamination direction T, electric charge accumulates at a portion where the body portions 15A face each other, with the result that the characteristics of a capacitor are exhibited. The details of the internal electrode 15 will be described later.

The outer layer portion 12 is an assembly of a plurality of the dielectric layers 14 made of the same dielectric ceramic material as the dielectric layers 14 of the inner layer portion 11.

The outer electrodes 3 include a first outer electrode 3A and a second outer electrode 3B.

The first outer electrode 3A covers the first end surface C1 of the multilayer body 2 and be connected to the internal electrodes 15 extended to the first end surface C1. The first outer electrode 3A is preferably provided so as to extend to a portion of the first main surface A1, a portion of the second main surface A2, a portion of the first side surface B1, and a portion of the second side surface B2. Of course, the first outer electrode 3A may be only on the first end surface C1.

The second outer electrode 3B covers the second end surface C2 of the multilayer body 2 and be connected to the internal electrodes 15 extended to the second end surface C2. The second outer electrode 3B is preferably provided so as to extend to a portion of the first main surface A1, a portion of the second main surface A2, a portion of the first side surface B1, and a portion of the second side surface B2. Of course, the second outer electrode 3B may be only on the second end surface C2.

Hereinafter, when it is not necessary to distinguish the first outer electrode 3A and the second outer electrode 3B from each other, the first outer electrode 3A and the second outer electrode 3B are collectively described as an outer electrode 3. The outer electrode 3 includes a base electrode layer 31 and a plating layer 32.

The base electrode layer 31 includes at least one selected from among a baked layer, a resin layer, a thin film layer, and the like. The base electrode layer 31 coats the end surface C of the multilayer body 2 and be connected to the internal electrodes 15 extended to the end surface C.

The baked layer includes a glass component and a metal. The glass component includes at least one selected from among B, Si, Ba, Mg, Al, Li, and the like. The metal of the baked layer includes, for example, at least one selected from among Cu, Ni, Ag, Pd, Ag—Pd alloy, Au, and the like. The baked layer may be made up of multiple layers. The baked layer is formed by applying conductive paste containing glass and metal onto the multilayer body 2 and then baking the conductive paste. The baked layer may be co-fired with the internal electrodes 15 and the dielectric layers 14 or may be baked after the internal electrodes 15 are fired. When the baked layer is co-fired with the internal electrodes 15 and the dielectric layers 14, it is preferable to add a dielectric material instead of the glass component to form the baked layer. The thickness of the thickest a portion of the baked layer is preferably, for example, greater than or equal to about 10 μm and less than or equal to about 50 μm, for example.

The resin layer may include multiple layers. The resin layer includes, for example, electrically conductive particles and a thermosetting resin. When the resin layer is formed, the resin layer may be formed directly on the multilayer body without forming a baked electrode layer, or the resin layer may be formed so as to coat the baked layer. The resin layer may be formed on the surface of the baked layer or may be formed directly on the surface of end surface C without forming a baked layer. The thickness of the resin layer (at the thickest part) is preferably greater than or equal to about 10 μm and less than or equal to about 150 μm, for example.

The thin film layer is formed by a thin film formation method, such as sputtering and evaporation, and is a layer less than or equal to about 1 μm where metal particles are deposited.

The plating layer 32 covers the base electrode layer 31. The plating layer 32 includes, for example, at least one selected from among Cu, Ni, Sn, Ag, Pd, Ag—Pd alloy, Au, and the like. The plating layer 32 may be formed in multiple layers. Preferably, the plating layer 32 has a two-layer structure of Ni plating 321 and Sn plating 322. The Ni plating layer 321 can reduce or prevent erosion of the base electrode layer 31 by solder used when a ceramic electronic component is mounted. The Sn plating layer 322 improves the wettability of solder used when a ceramic electronic component is mounted, so the ceramic electronic component can be easily mounted. The thickness per layer of the plating layer 32 is preferably greater than or equal to about 0.5 μm and less than or equal to about 10 μm, for example.

Next, the internal electrodes 15 will be described in detail. As described above, the internal electrodes 15 include a plurality of sets of the first internal electrode 151, the second internal electrode 152, the third internal electrode 153, and the fourth internal electrode 154. The first internal electrode 151, the second internal electrode 152, the third internal electrode 153, and the fourth internal electrode 154 are all on different planes between the dielectric layers 14.

The first internal electrode 151 includes a substantially rectangular parallelepiped first body portion 151A and a first extended portion 151B extending from the first body portion 151A to the first end surface C1 and connected to the first outer electrode (described later). The second internal electrode 152 includes a substantially rectangular parallelepiped second body portion 152A and a second extended portion 152B extending from the second body portion 152A to the second end surface C2 and connected to the second outer electrode (described later). The third internal electrode 153 includes a substantially rectangular parallelepipedo third body portion 153A and a third extended portion 153B extending from the third body portion 153A to the first end surface C1 and connected to the first outer electrode (described later). The fourth internal electrode 154 includes a substantially rectangular parallelepiped fourth body portion 154A and a fourth extended portion 154B extending from the fourth body portion 154A to the second end surface C2 and connected to the second outer electrode (described later).

In the present example embodiment, the internal electrodes 15 are arranged in the order of the first internal electrode 151, the second internal electrode 152, the third internal electrode 153, and the fourth internal electrode 154. However, as long as the first internal electrode 151 or the third internal electrode 153 and the second internal electrode 152 or the fourth internal electrode 154 are alternately arranged, the first internal electrode 151, the second internal electrode 152, the third internal electrode 153, and the fourth internal electrode 154 in each set do not need to be arranged in the same order.

In other words, it is sufficient that the first internal electrode 151, the second internal electrode 152, the third internal electrode 153, and the fourth internal electrode 154 are arranged in the order of one of the first internal electrode 151 or the third internal electrode 153, one of the second internal electrode 152 or the fourth internal electrode 154, the other of the first internal electrode 151 or the third internal electrode 153, and the other of the second internal electrode 152 or the fourth internal electrode 154.

For example, the first internal electrode 151, the second internal electrode 152, the third internal electrode 153, and the fourth internal electrode 154 may be arranged in the order of the first internal electrode 151, the second internal electrode 152, the third internal electrode 153, and the fourth internal electrode 154, or in the order of the first internal electrode 151, the fourth internal electrode 154, the third internal electrode 153, and the second internal electrode 152, or in the order of the third internal electrode 153, the second internal electrode 152, the first internal electrode 151, and the fourth internal electrode 154, or in the order of the third internal electrode 153, the fourth internal electrode 154, the first internal electrode 151, and the second internal electrode 152, and these sets may be mixed.

However, when sets with the same order are repeatedly laminated, it is possible to avoid complexity in a manufacturing process.

Hereinafter, when it is not necessary to distinguish among the first body portion 151A, the second body portion 152A, the third body portion 153A, and the fourth body portion 154A, the first body portion 151A, the second body portion 152A, the third body portion 153A, and the fourth body portion 154A are collectively referred to as a body portion 15A. When it is not necessary to distinguish among the first extended portion 151B, the second extended portion 152B, the third extended portion 153B, and the fourth extended portion 154B, the first extended portion 151B, the second extended portion 152B, the third extended portion 153B, and the fourth extended portion 154B are collectively referred to as an extended portion 15B.

The body portion 15A of the present example embodiment has a substantially rectangular shape with two end edges along the end surfaces C and two side edges along the side surfaces B. The body portion 15A includes four end portions that are rectangular corner portions. Of the four end portions, two end portions on the side where the extended portion 15B extends and is connected to the end surface C are referred to as connection-side end portions 15c, and two end portions on the side where the extended portion 15B does not extend and is connected to the other end surface C are referred to as non-connection-side end portions 15n.

The first body portion 151A of the first internal electrode 151 includes first non-connection-side end portions 151n located on the second end surface C2 side and first connection-side end portions 151c located on the first end surface C1 side. The second body portion 152A of the second internal electrode 152 includes second non-connection-side end portions 152n located on the first end surface C1 side and second connection-side end portions 152c located on the second end surface C2 side. The third body portion 153A of the third internal electrode 153 includes third non-connection-side end portions 153n located on the second end surface C2 side and third connection-side end portions 153c located on the first end surface C1 side. The fourth body portion 154A of the fourth internal electrode 154 includes fourth non-connection-side end portions 154n located on the first end surface C1 side and fourth connection-side end portions 154c located on the second end surface C2 side.

FIG. 4 is a cross-sectional view taken along line IV-IV in FIG. 1, which passes through two end portions located on the first side surface B1 side of the four end portions of the body portion 15A, as described above.

As shown in the drawing, the multilayer ceramic capacitor 1 of the present example embodiment includes the following feature 1. The first connection-side end portion 151c and the third connection-side end portion 153c do not overlap with each other in the lamination direction T, and the second connection-side end portion 152c and the fourth connection-side end portion 154c do not overlap with each other in the lamination direction T. In other words, the first connection-side end portion 151c and the third connection-side end portion 153c are located at different positions in the length direction L, and the second connection-side end portion 152c and the fourth connection-side end portion 154c are located at different positions in the length direction L.

In other words, in the example embodiment, the first extended portion 151B and the third extended portion 153B have different dimensions in the length direction L, and the second extended portion 152B and the fourth extended portion 154B have different dimensions in the length direction L.

In the present example embodiment, the first connection-side end portion 151c and the third connection-side end portion 153c are located at the same position in the width direction W, and the second connection-side end portion 152c and the fourth connection-side end portion 154c are located at the same position in the width direction W; however, the configuration is not limited thereto. The first connection-side end portion 151c and the third connection-side end portion 153c may be located at different positions in the width direction W, and the second connection-side end portion 152c and the fourth connection-side end portion 154c may be located at different positions in the width direction W.

In the present example embodiment, the position of the first connection-side end portion 151c in the length direction L from the first end surface C1 is farther than the position of the third connection-side end portion 153c in the length direction L from the first end surface C1. However, the configuration is not limited thereto, and the position may be closer. The position of the second connection-side end portion 152c in the length direction L from the second end surface C2 is farther than the position of the fourth connection-side end portion 154c in the length direction L from the second end surface C2. However, the configuration is not limited thereto, and the position may be closer.

In other words, the dimension of the first extended portion 151B in the length direction L may be smaller than or may be larger than the dimension of the third extended portion 153B in the length direction L. The dimension of the second extended portion 152B in the length direction L may be smaller than or may be larger than the dimension of the fourth extended portion 154B in the length direction L.

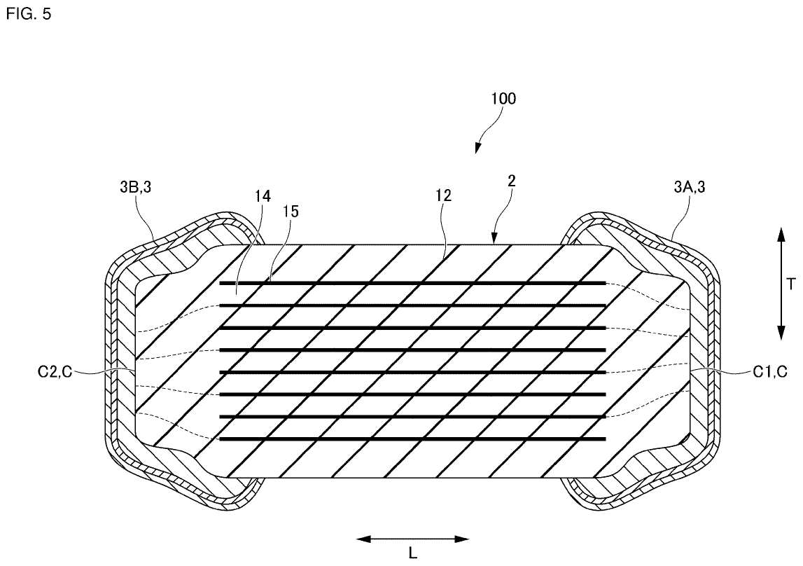

FIG. 5 is a cross-sectional view of an existing multilayer ceramic capacitor 100, corresponding to FIG. 4. Hereinafter, in the description of the existing multilayer ceramic capacitor 100, the same reference signs are assigned to denote the same portions as in the present example embodiment.

In the existing multilayer ceramic capacitor 100, the respective end portions of the internal electrodes 15 overlap in the lamination direction T. In other words, the respective end portions of the internal electrodes 15 are located at the same positions in the length direction L. In this case, as illustrated, when viewed from the central side of the multilayer body 2 in the length direction L toward the end surface C side, the thickness abruptly changes at the position where the structure changes from a region where the plurality of internal electrodes 15 is laminated to a region where no internal electrode 15 is laminated.

In this way, during the manufacturing process of the existing multilayer ceramic capacitor 100, when the multilayer body 2 is pressure-bonded in the lamination direction T, an abrupt flow or elongation occurs in the dielectric sheets, which constitute the dielectric layers 14 and the outer layer portions 12, to cause the dielectric sheets to be strongly pulled in the vicinity of the end portions of the internal electrodes 15. As a result, there are cases where the dielectric sheets in the vicinity of the end portions of the internal electrodes 15 cannot follow the shape of the abrupt thickness change in the vicinity of the end portions of the overlapping internal electrodes 15. As a result, the adhesion during pressure bonding at the interfaces between the outer layer portion 12, the dielectric layers 14, and the internal electrodes 15 decreases, so, in some cases, voids occur therebetween and delamination starting from these voids occurs.

In the present example embodiment, with the above feature 1, as shown in FIG. 4, when viewed from the central side of the multilayer body 2 in the length direction L toward the end surface C side, the number of laminated internal electrodes 15 gradually decreases. In other words, the rate of reduction in the number of overlapping internal electrodes 15 is gradual. As a result, an abrupt flow or elongation of the dielectric sheets, which constitute the dielectric layers 14 and the outer layer portions 12, in the vicinity of the end portions of the internal electrodes 15 is reduced or prevented when the multilayer body 2 is pressure-bonded in the lamination direction T. Therefore, it is possible to follow the shape of the abrupt thickness change in the vicinity of the end portions of the overlapping internal electrodes 15, so the adhesion during pressure bonding between the dielectric sheets or between the dielectric sheet and the internal electrode 15 is improved, and the likelihood of occurrence of voids or occurrence of delamination from the voids is reduced.

Whether the multilayer ceramic capacitor 1 has feature 1 can be confirmed as follows.
(1) Initially, in a cross section along the length direction L and the width direction W in the center portion of the multilayer ceramic capacitor 1 in the lamination direction T, for example, a distance W1 (not shown) from the first side surface B1 to each of the first connection-side end portion 151c, the second connection-side end portion 152c, the third connection-side end portion 153c, and the fourth connection-side end portion 154c is measured.
(2) Subsequently, the multilayer ceramic capacitor 1 is ground along a cross section passing through the length direction L and the lamination direction T by the distance W1 from the first side surface B1 side. Then, as shown in FIG. 4, the first connection-side end portions 151c, the second connection-side end portions 152c, the third connection-side end portions 153c, and the fourth connection-side end portions 154c appear in the cross section. In the cross section, when the multilayer ceramic capacitor 1 has feature 1, a state where the number of overlapping internal electrodes 15 gradually decreases from the center portion side in the length direction L toward the first end surface C1 and the second end surface C2 can be observed.

In the present example embodiment, the multilayer ceramic capacitor 1 further has the following feature 2 as a more preferable example embodiment. In the lamination direction T, the first non-connection-side end portion 151n, the second connection-side end portion 152c, and the fourth connection-side end portion 154c do not overlap with one another, the second non-connection-side end portion 152n, the first connection-side end portion 151c, and the third connection-side end portion 153c do not overlap with one another, the third non-connection-side end portion 153n, the second connection-side end portion 152c, and the fourth connection-side end portion 154c do not overlap with one another, and the fourth non-connection-side end portion 154n, the first connection-side end portion 151c, and the third connection-side end portion 153c do not overlap with one another.

In this present example embodiment, among the positions of the first non-connection-side end portion 151n, the second connection-side end portion 152c, and the fourth connection-side end portion 154c in the length direction L from the second end surface C2, the first non-connection-side end portion 151n is the farthest. However, the configuration is not limited thereto, and the first non-connection-side end portion 151n may be the closest. Alternatively, the first non-connection-side end portion 151n may be disposed between the second connection-side end portion 152c and the fourth connection-side end portion 154c.

Among the positions of the second non-connection-side end portion 152n, the first connection-side end portion 151c, and the third connection-side end portion 153c in the length direction L from the first end surface C1, the second non-connection-side end portion 152n is the farthest. However, the configuration is not limited thereto, and the second non-connection-side end portion 152n may be the closest. Alternatively, the second non-connection-side end portion 152n may be disposed between the first connection-side end portion 151c and the third connection-side end portion 153c.

Among the positions of the third non-connection-side end portion 153n, the second connection-side end portion 152c, and the fourth connection-side end portion 154c in the length direction L from the second end surface C2, the third non-connection-side end portion 153n is the farthest. However, the configuration is not limited thereto, and the third non-connection-side end portion 153n may be the closest. Alternatively, the third non-connection-side end portion 153n may be disposed between the second connection-side end portion 152c and the fourth connection-side end portion 154c.

Among the positions of the fourth non-connection-side end portion 154n, the first connection-side end portion 151c, and the third connection-side end portion 153c in the length direction L from the first end surface C1, the fourth non-connection-side end portion 154n is the farthest. However, the configuration is not limited thereto, and the fourth non-connection-side end portion 154n may be the closest. Alternatively, the fourth non-connection-side end portion 154n may be disposed between the first connection-side end portion 151c and the third connection-side end portion 153c.

When the multilayer ceramic capacitor 1 has feature 1, feature 2 is not indispensable. However, when the multilayer ceramic capacitor 1 additionally has feature 2, the advantageous effects described in feature 1 can be further enhanced.

In the present example embodiment, the multilayer ceramic capacitor 1 further has the following feature 3 as a more preferable example embodiment of the present invention. In the lamination direction T, the first non-connection-side end portion 151n and the third non-connection-side end portion 153n do not overlap with each other, and the second non-connection-side end portion 152n and the fourth non-connection-side end portion 154n do not overlap with each other.

In the present example embodiment, the position of the second non-connection-side end portion 152n in the length direction L from the first end surface C1 is farther than the position of the fourth non-connection-side end portion 154n in the length direction L from the first end surface C1. However, the configuration is not limited thereto, and the position may be closer. The position of the first non-connection-side end portion 151n in the length direction L from the second end surface C2 is farther than the position of the third non-connection-side end portion 153n in the length direction L from the second end surface C2; however, the configuration is not limited thereto, and the position may be closer.

When the multilayer ceramic capacitor 1 has feature 1, feature 3 is not indispensable. However, when the multilayer ceramic capacitor 1 additionally has feature 3, the advantageous effects described in feature 1 can be further enhanced.

Overall, when the multilayer ceramic capacitor 1 has feature 1, other features are not indispensable, and, as a more preferable example embodiment, it is preferable that none of the end portions overlap with each other in the lamination direction T. In other words, as the end portions of a side of the first end surface C1, it is preferable that the first connection-side end portion 151c of the first internal electrode 151, the second non-connection-side end portion 152n of the second internal electrode 152, the third connection-side end portion 153c of the third internal electrode 153, and the fourth non-connection-side end portion 154n of the fourth internal electrode 154 do not overlap in the lamination direction T.

As the end portions of the second end surface C2 side, it is preferable that the first non-connection-side end portion 151n of the first internal electrode 151, the second connection-side end portion 152c of the second internal electrode 152, the third non-connection-side end portion 153n of the third internal electrode 153, and the fourth connection-side end portion 154c of the fourth internal electrode 154 do not overlap in the lamination direction T.

For example, as long as the first connection-side end portion 151c, the second non-connection-side end portion 152n, the third connection-side end portion 153c, and the fourth non-connection-side end portion 154n do not overlap in the lamination direction T, the positions of the first connection-side end portion 151c, the second non-connection-side end portion 152n, the third connection-side end portion 153c, and the fourth non-connection-side end portion 154n in the length direction L from the first end surface C1 may be in any order.

As long as the first non-connection-side end portion 151n, the second connection-side end portion 152c, the third non-connection-side end portion 153n, and the fourth connection-side end portion 154c do not overlap in the lamination direction T, the positions of the first non-connection-side end portion 151n, the second connection-side end portion 152c, the third non-connection-side end portion 153n, and the fourth connection-side end portion 154c in the length direction L from the second end surface C2 may be in any order.

In the above, each of the internal electrodes 15 has the substantially rectangular parallelepiped body portion 15A and the extended portion 15B extending from the body portion 15A to one end surface C and connected to the outer electrode. The extended portion 15B having a substantially rectangular parallelepipedo shape with a dimension in the width direction W smaller than the dimension of the body portion 15A in the width direction W has been described. However, the configuration is not limited thereto, and, for example, each of the internal electrodes 15 may have the following forms.

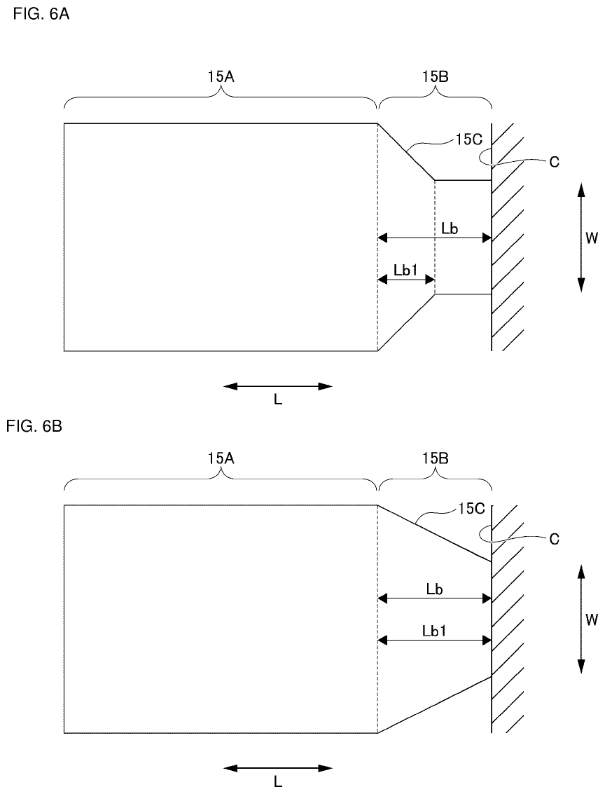

FIGS. 6A and 6B show diagrams that illustrate a first modification of the internal electrode 15. FIGS. 6A and 6B collectively illustrate the first internal electrode 151, the second internal electrode 152, the third internal electrode 153, and the fourth internal electrode 154. In the first modification as well, reference signs similar to those of the present example embodiment are used for description.

As illustrated, the extended portion 15B of the internal electrode 15 in the first modification includes an inclined portion 15C of which the dimension in the width direction W decreases from the body portion 15A side toward one end surface.

In other words, in the first modification, the first extended portion 151B of the first internal electrode 151 has a first inclined portion of which the dimension in the width direction W decreases from the first body portion 151A side of the first extended portion 151B toward the first end surface C1, the second extended portion 152B of the second internal electrode 152 has a second inclined portion of which the dimension in the width direction W decreases from the second body portion 152A side of the second extended portion 152B toward the second end surface C2, the third extended portion 153B of the third internal electrode 153 has a third inclined portion of which the dimension in the width direction W decreases from the third body portion 153A side of the third extended portion 153B toward the first end surface C1, and the fourth extended portion 154B of the fourth internal electrode 154 has a fourth inclined portion of which the dimension in the width direction W decreases from the fourth body portion 154A side of the fourth extended portion 154B toward the second end surface C2.

The dimension Lb1 of the inclined portion 15C in the length direction L is larger than or equal to about 1% and less than or equal to about 100% of the dimension Lb of the extended portion 15B in the length direction L. FIG. 6A is a diagram that shows an example in which Lb1 is about 50% of Lb, and FIG. 6B is a diagram that shows an example in which Lb1 is about 100% of Lb. As shown in FIG. 6A, a portion of the extended portion 15B, other than the inclined portion 15C, may have a rectangular shape. As shown in FIG. 6B, the entire extended portion 15B may have an inclined portion of which the width dimension gradually decreases.

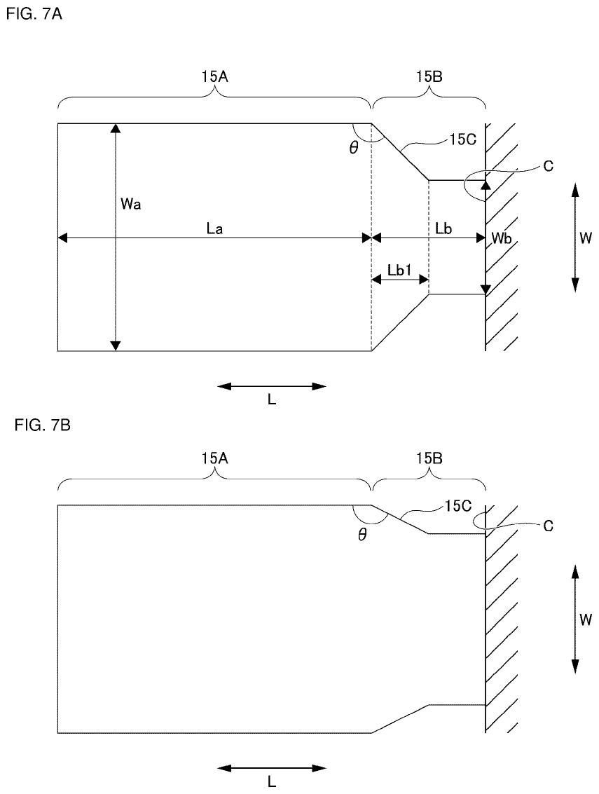

FIGS. 7A and 7B show diagrams that illustrate a second modification of the internal electrode 15. FIGS. 7A and 7B also collectively illustrates the first internal electrode 151, the second internal electrode 152, the third internal electrode 153, and the fourth internal electrode 154.

As illustrated, the extended portion 15B of the internal electrode 15 in the second modification includes an inclined portion 15C of which the dimension in the width direction W decreases from the body portion 15A side toward one end surface, similarly to the first modification.

The inclination angle θ of the internal electrode 15 in FIG. 7A is smaller than the inclination angle θ of the internal electrode 15 in FIG. 7B. Here, the inclination angle θ is the angle formed between a line that is substantially parallel to the length direction L and the contour of the inclined portion. In the second modification, the inclination angle θ of the first extended portion 151B connected to the first end surface C1 is different from the inclination angle θ of the third extended portion 153B connected to the first end surface C1. For example, when one of FIG. 7A or 7B is the first extended portion 151B, the other of FIG. 7A or 7B is the third extended portion 153B. The inclination angle θ of the second extended portion 152B connected to the second end surface C2 is different from the inclination angle θ of the fourth extended portion 154B connected to the second end surface C2. For example, when one of FIG. 7A or 7B is the second extended portion 152B, the other of FIG. 7A or 7B is the fourth extended portion 154B.

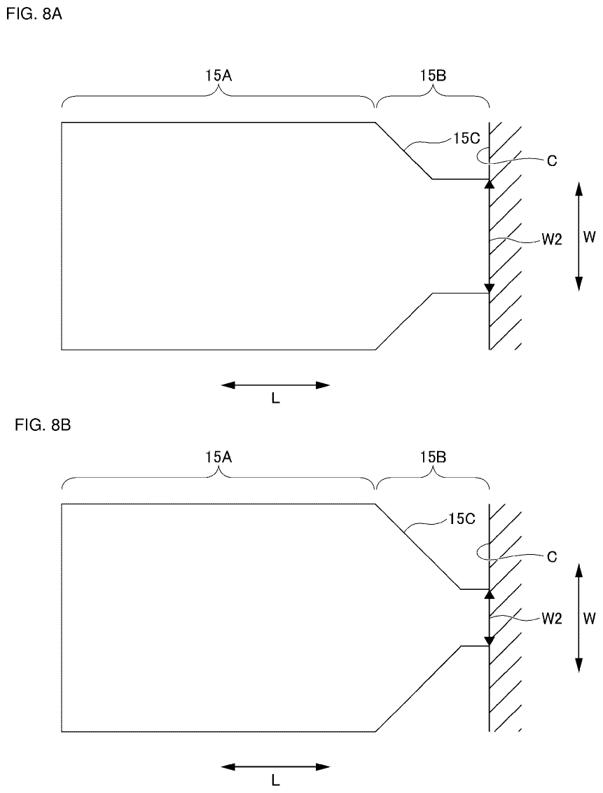

FIGS. 8A and 8B show diagrams that illustrate third and fourth modifications of the internal electrode 15. FIGS. 8A and 8B also collectively illustrates the first internal electrode 151, the second internal electrode 152, the third internal electrode 153, and the fourth internal electrode 154.

As illustrated, the extended portion 15B of the internal electrode 15 in the third and fourth modifications has an inclined portion 15C of which the dimension in the width direction W decreases from the body portion 15A side toward one end surface, similarly to the first modification.

The dimension, in the width direction W2, of the connecting portion with the end surface C in the extended portion 15B of the internal electrode 15 in FIG. 8A is larger than the dimension, in the width direction W2, of the connecting portion with the end surface C in the extended portion 15B of the internal electrode 15 in FIG. 8B.

In the third modification, the dimension W2, in the width direction W, of the connecting portion of the first extended portion 151B connected to the first end surface C1 is different from the dimension W2, in the width direction W, of the connecting portion of the third extended portion 153B connected to the first end surface C1. For example, when one of FIG. 8A or 8B are the first extended portion 151B, the other of FIG. 8A or 8B are the third extended portion 153B.

The dimension W2, in the width direction W, of the connecting portion of the second extended portion 152B connected to the second end surface C2 is different from the dimension W2, in the width direction W, of the connecting portion of the fourth extended portion 154B connected to the second end surface C2. For example, when one of FIG. 8A or 8B is the second extended portion 152B, the other of FIG. 8A or 8B are the fourth extended portion 154B.

In a fourth modification, the dimension W2, in the width direction W, of the connecting portion of the first extended portion 151B is different from the dimension W2, in the width direction W, of the connecting portion of the second extended portion 152B. The dimension W2, in the width direction W, of the connecting portion of the third extended portion 153B is different from the dimension W2, in the width direction W, of the connecting portion of the fourth extended portion 154B. For example, when one of FIG. 8A or 8B are the first extended portion 151B, the other of FIG. 8A or 8B are the second extended portion 152B. When one of FIG. 8A or 8B are the third extended portion 153B, the other of FIG. 8A or 8B are the fourth extended portion 154B.

In a fifth modification, the dimension of the first extended portion 151B in the width direction W may be different from the dimension of the second extended portion 152B in the width direction W, and the dimension of the third extended portion 153B in the width direction W may be different from the dimension of the fourth extended portion 154B in the width direction W.

In a sixth modification, the dimension of the first internal electrode 151 in the width direction W at the first end surface C1 may be different from the dimension of the third internal electrode 153 in the width direction W at the first end surface C1, and the dimension of the second internal electrode 152 in the width direction W at the second end surface C2 may be different from the dimension of the fourth internal electrode 154 in the width direction W at the second end surface C2.

In a seventh modification, additionally, the first internal electrode 151 may have a first coupling portion coupled to the first body portion 151A and on the second end surface C2 side, the first coupling portion having a shape of which the dimension in the width direction W gradually decreases. The second internal electrode 152 may have a second coupling portion coupled to the second body portion 152A and on the first end surface C1 side, the second coupling portion having a shape of which the dimension in the width direction W gradually decreases. The third internal electrode 153 may have a third coupling portion coupled to the third body portion 153A and on the second end surface C2 side, the third coupling portion having a shape of which the dimension in the width direction W gradually decreases. The fourth internal electrode 154 may have a fourth coupling portion coupled to the fourth body portion 154A and on the first end surface C1 side, the fourth coupling portion having a shape of which the dimension in the width direction W gradually decreases.

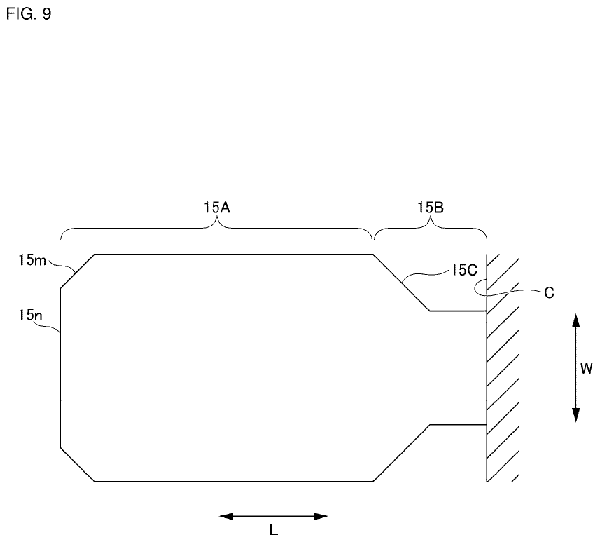

FIG. 9 is a diagram that shows an eighth modification of the internal electrode 15. As illustrated, the non-connection-side end portion 15n of the body portion 15A of the internal electrode 15 may have a shape with cutouts 15m where the corner portions are diagonally cut away. The shape with cutouts 15m where the corner portions are diagonally cut away refers to a shape in which the non-connection-side end portions 15n that are substantially right-angled in the present example embodiment are diagonally cut, that is, cut away in a triangular shape.

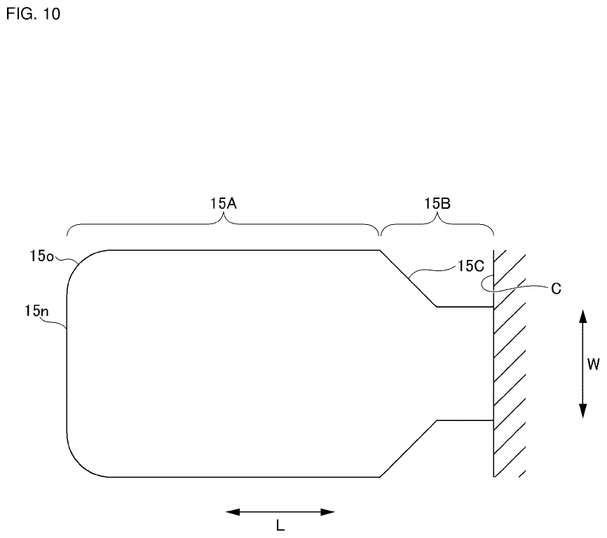

FIG. 10 is a diagram that shows a ninth modification of the internal electrode 15. As illustrated, the non-connection-side end portion 15n of the body portion 15A of the internal electrode 15 may have a shape with cutouts 150 where the corner portions are cut away in an arcuate shape. The shape with cutouts 150 where the corner portions are cut away in an arcuate shape refers to a shape in which the non-connection-side end portions 15n that are substantially right-angled in the present example embodiment are cut in an arcuate shape and the contours of the non-connection-side end portions 15n have an arcuate shape.

The multilayer ceramic capacitors 1 of the example embodiments, including the modifications, can be manufactured by the following steps.

For example, a barium titanate-based material is prepared as ceramic raw material powder, polyvinyl butyral is prepared as a resin binder, dioctyl phthalate is prepared as a plasticizer, and ethanol and toluene are prepared as solvents, and these materials are mixed and dispersed to prepare ceramic slurry.

Subsequently, a ceramic green sheet with a thickness of about 3 μm, for example, is produced using the ceramic slurry.

Then, conductive paste with non-metal powder as a conductive component is printed onto the surface of the ceramic green sheet (ceramic layer) using a screen printing method. The printing method is not limited to screen printing and may be gravure printing, or the like. In the internal electrode printing step, a ceramic green sheet on which the patterns of the first internal electrode 151 and the second internal electrode 152 are printed, and a ceramic green sheet on which the patterns of the third internal electrode 153 and the fourth internal electrode 154 are printed are prepared.

When the inclined portions 15C are provided as in the case of the modifications, that is, when the first internal electrode 151 includes the first extended portion 151B with an inclined portion of which the width dimension gradually decreases, the second internal electrode 152 includes the second extended portion 152B with an inclined portion of which the width dimension gradually decreases, the third internal electrode 153 includes the third extended portion 153B with an inclined portion of which the width dimension gradually decreases, and the fourth internal electrode 154 includes the fourth extended portion 154B with an inclined portion of which the width dimension gradually decreases, ceramic green sheets with the printed patterns of the internal electrodes 15 having these shapes are prepared.

In the present example embodiment, internal electrode patterns in which the first extended portion 151B and the third extended portion 153B have different dimensions in the length direction L and the second extended portion 152B and the fourth extended portion 154B have different dimensions in the length direction L are printed on the ceramic green sheets.

Alternatively, the first extended portion 151B and the third extended portion 153B having the same dimension in the length direction L may be printed, the second extended portion 152B and the fourth extended portion 154B having the same dimension in the length direction L may be printed, and, in the subsequent lamination step (4), the ceramic green sheets may be laminated while the internal electrode patterns are shifted such that the first connection-side end portion 151c and the third connection-side end portion 153c do not overlap in the lamination direction T and the second connection-side end portion 152c and the fourth connection-side end portion 154c do not overlap in the lamination direction T.

Then, the ceramic green sheets with the internal electrode patterns are laminated, ceramic green sheets (dummy sheets) 3b without internal electrode patterns are further laminated above and below to form a mother block. The mother block is pressed and is then cut to obtain an unfired multilayer body 2 with product dimensions of about 3.2 mm in length, about 1.6 mm in width, and about 1.6 mm in height, for example.

Here, when the internal electrode patterns in which the first extended portion 151B and the third extended portion 153B have different dimensions in the length direction L and the second extended portion 152B and the fourth extended portion 154B have different dimensions in the length direction L are printed on the surfaces of the ceramic green sheets, the ceramic green sheets are laminated while the positions of the ceramic green sheets are adjusted such that the first non-connection-side end portion 151n and the third non-connection-side end portion 153n overlap and the second non-connection-side end portion 152n and the fourth non-connection-side end portion 154n overlap.

In this way, it is possible to naturally ensure that the first connection-side end portion 151c and the third connection-side end portion 153c do not overlap in the lamination direction T and the second connection-side end portion 152c and the fourth connection-side end portion 154c do not overlap in the lamination direction T.

When the first extended portion 151B and the third extended portion 153B are printed so as to have the same dimension in the length direction L and the second extended portion 152B and the fourth extended portion 154B are printed so as to have the same dimension in the length direction L, the ceramic green sheets are laminated while being shifted in the length direction L such that the first connection-side end portion 151c and the third connection-side end portion 153c do not overlap in the lamination direction T and the second connection-side end portion 152c and the fourth connection-side end portion 154c do not overlap in the lamination direction T. The shift amount at this time is adjusted to such an extent that the first body portion 151A and the third body portion 153A are not extended to the second end surface C2 and the second body portion 152A and the fourth body portion 154A are not extended to the first end surface C1.

After that, the product is degreased and then fired at a temperature of 1300 °C in an atmosphere furnace of N₂+H₂ (H₂=5%).

After firing, Cu paste is applied onto both end sides of the multilayer body 2 and baked, and Ni plating and Sn plating are sequentially applied on it, to form a pair of outer electrodes 3.

As a result, the multilayer ceramic capacitor 1 of the present example embodiment is obtained.

Next, the results of experiments conducted to verify the effect of reducing occurrence of delamination in the multilayer ceramic capacitor 1 of the present example embodiment will be described. To verify the effect, examples of a multilayer ceramic capacitor of Comparative Example and multilayer ceramic capacitors of Examples according to the example embodiment were prepared.

### Multilayer Ceramic Capacitor of a Comparative Example Embodiment (Existing Product)

### Chip Size:

The dimension in the length direction L was 2.1 mm.

The dimension in the width direction W was 1.3 mm.

The dimension in the lamination direction T was 1.3 mm.

### Internal Electrode Shape:

The body portion had a rectangular shape.

The extended portion had an inclined portion, and a portion of the extended portion, other than the inclined portion, had a rectangular shape.

The multilayer ceramic capacitor of the above-described comparative example embodiment was formed by lamination such that all the first connection-side end portions 151c and the third connection-side end portions 153c overlapped in the lamination direction T. Lamination was performed such that all the second connection-side end portions 152c and the third connection-side end portions 153c overlapped in the lamination direction T.

The distance (shift amount of the end portions) in the length direction L between the first connection-side end portion 151c and the third connection-side end portion 153c was 0 μm.

The distance (shift amount of the end portions) in the length direction L between the second connection-side end portion 152c and the fourth connection-side end portion 154c was 0 μm.

### Example 1

### Multilayer Ceramic Capacitor of Example 1

### Chip Size:

The dimension in the length direction L was 2.1 mm.

The dimension in the width direction W was 1. 3 mm.

The dimension in the lamination direction T was 1.3 mm.

### Internal Electrode Shape:

The body portion had a rectangular shape.

The extended portion had an inclined portion, and a portion of the extended portion, other than the inclined portion, had a rectangular shape.

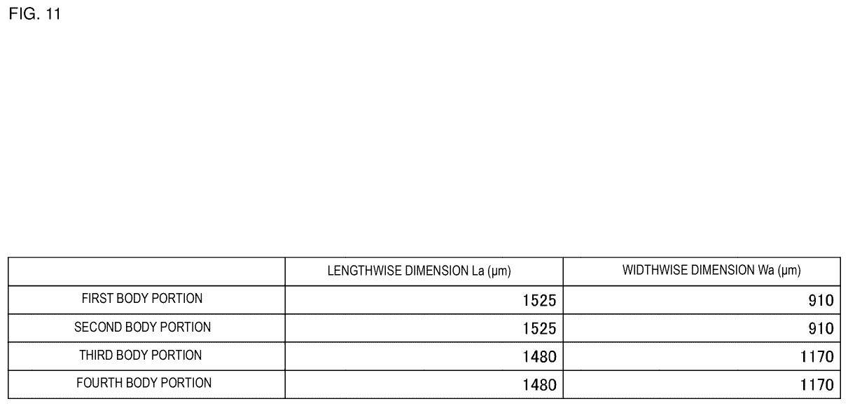

FIG. 11 shows the dimensions of the body portion 151A of the first internal electrode 151, the body portion 152A of the second internal electrode 152, the body portion 153A of the third internal electrode 153, and the body portion 153A of the fourth internal electrode 154 of the multilayer ceramic capacitor 1 of Example 1.

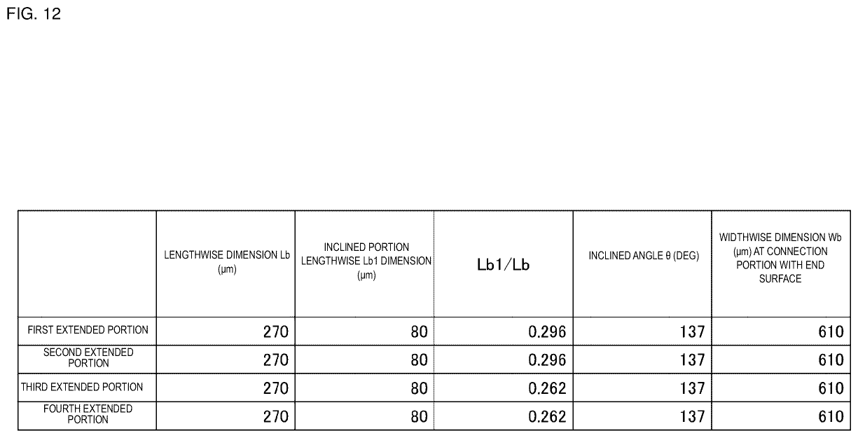

FIG. 12 shows the dimensions of the extended portion 151B of the first internal electrode 151, the extended portion 152B 4 the second internal electrode 152, the extended portion 153B of the third internal electrode 153, and the extended portion 154B of the fourth internal electrode 154 of the multilayer ceramic capacitor 1 of Example 1. The positions of the respective dimensions are shown in FIG. 7A.

The first internal electrode 151, the second internal electrode 152, the third internal electrode 153, and the fourth internal electrode 154 with sizes shown in FIGS. 11 and 12 were laminated such that the first connection-side end portion 151c and the third connection-side end portion 153c did not overlap in the lamination direction T and the second connection-side end portion 152c and the fourth connection-side end portion 154c did not overlap in the lamination direction T.

The distance (shift amount) Ld1 in the length direction L between the first connection-side end portion 151c and the third connection-side end portion 153c was 45 μm, and the distance (shift amount) Ld2 in the length direction L between the second connection-side end portion 152c and the fourth connection-side end portion 154c was 45 μm. The positions of the shift amounts are shown in FIG. 4.

### Example 2

### Multilayer Ceramic Capacitor of Example 2

### Chip Size:

The dimension in the length direction L was 2.0 mm.

The dimension in the width direction W was 1.2 mm.

The dimension in the lamination direction T was 1.2 mm.

### Internal Electrode Shape:

The body portion had a rectangular shape.

The extended portion had an inclined portion, and a portion of the extended portion, other than the inclined portion, had a rectangular shape.

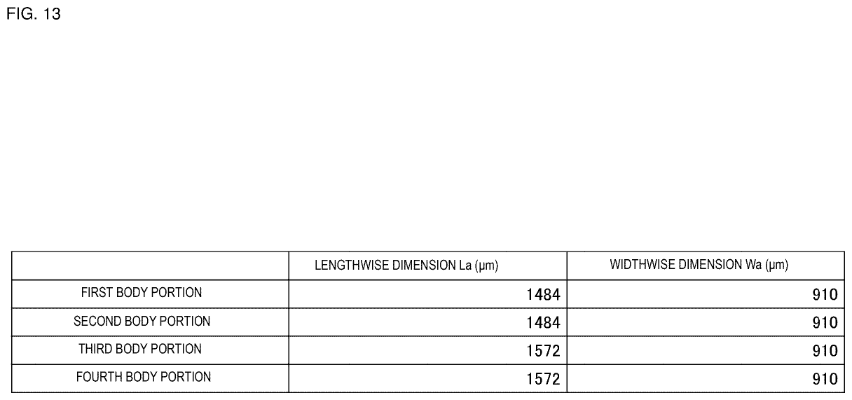

FIG. 13 shows the dimensions of the body portion 151A of the first internal electrode 151, the body portion 152A of the second internal electrode 152, the body portion 153A of the third internal electrode 153, and the body portion 153A of the fourth internal electrode 154 of the multilayer ceramic capacitor 1 of Example 2.

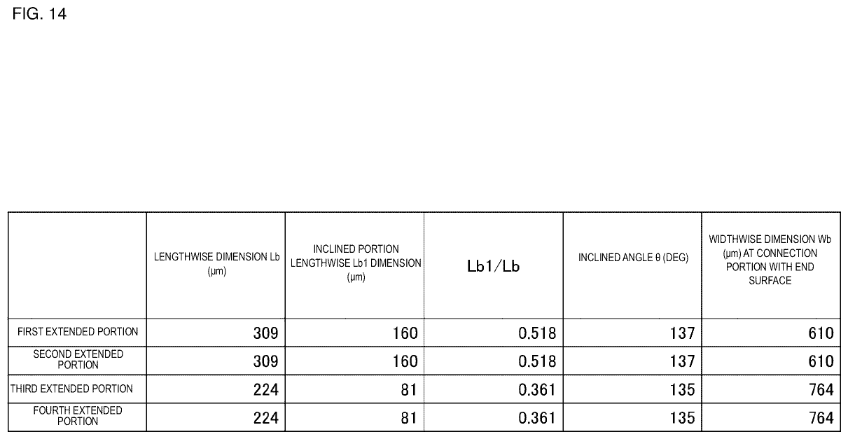

FIG. 14 shows the dimensions of the extended portion 151B of the first internal electrode 151, the extended portion 152B of the second internal electrode 152, the extended portion 153B of the third internal electrode 153, and the extended portion 154B of the fourth internal electrode 154 of the multilayer ceramic capacitor 1 of Example 2.

The first internal electrode 151, the second internal electrode 152, the third internal electrode 153, and the fourth internal electrode 154 with sizes shown in FIGS. 13 and 14 were laminated such that the first connection-side end portion 151c and the third connection-side end portion 153c did not overlap in the lamination direction T and the second connection-side end portion 152c and the fourth connection-side end portion 154c did not overlap in the lamination direction T.

The distance (shift amount) Ld1 in the length direction L between the first connection-side end portion 151c and the third connection-side end portion 153c was 88 μm, and the distance (shift amount) Ld1 in the length direction L between the second connection-side end portion 152c and the fourth connection-side end portion 154c was 88 μm.

Initially, it was confirmed that the shift amount of Comparative Example 1 was 0 μm, the shift amount Ld1 of Example 1 was 45 μm, and the shift amount Ld1 of Example 2 was 88 μm, by the above-described (Confirmation Method) as to whether the multilayer ceramic capacitor 1 had feature 1.

Subsequently, defects due to delamination in Comparative Example 1, Example 1, and Example 2 were confirmed using the following method.
(1) To observe the internal electrodes 15 in the vicinity of the outer layer portion 12, the internal electrode 15 closest to the outer layer portion 12 was exposed, and then grinding was performed along the cross section in the length direction L and the width direction W from the exposed internal electrode 15 to a thickness corresponding to 3% of the total number of the internal electrodes 15 (a depth in the lamination direction T).
(2) The cross section was continuously observed using a microscope with a magnification of 200 times, and a multilayer ceramic capacitor in which void portions (white) were observed in the vicinity of the non-connection-side end portion 15n and the connection-side end portion 15c of the internal electrode 15 was determined as a multilayer ceramic capacitor in which delamination had occurred.

The same confirmation was performed on 50 multilayer ceramic capacitors for each of Comparative Example 1, Example 1, and Example 2. Then, the number of multilayer ceramic capacitors 1 in which delamination was observed was counted.

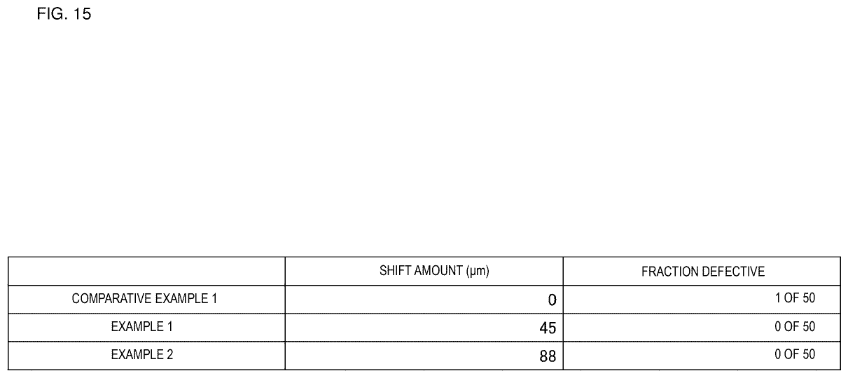

FIG. 15 shows the confirmation results of defects due to delamination in Comparative Example 1, Example 1, and Example 2. As shown in the table of FIG. 15, one defective multilayer ceramic capacitor in which delamination was found was present among 50 samples in Comparative Example, while no defective multilayer ceramic capacitors were present among 50 samples in Example 1 and Example 2.

As a result, the effect of reducing occurrence of delamination in the multilayer ceramic capacitors 1 of the example embodiments has been demonstrated.

Example embodiments of the present invention have been described above. However, the present invention is not limited to the above-described example embodiments, and various modifications and alterations like those described below are possible.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including:
a plurality of dielectric layers and a plurality of internal electrodes that are laminated with each other;
a first main surface and a second main surface opposite to each other in a lamination direction;
a first side surface and a second side surface opposite to each other in a width direction orthogonal to the lamination direction; and
a first end surface and a second end surface opposite to each other in a length direction orthogonal to the lamination direction and the width direction;
a first outer electrode on the first end surface; and
a second outer electrode on the second end surface; wherein
the internal electrodes include a first internal electrode, a second internal electrode, a third internal electrode, and a fourth internal electrode that are on different planes;
the first internal electrode includes:
a first body portion having a substantially rectangular shape or having a substantially rectangular shape with a cutout on a side of the first end surface; and
a first extended portion coupled to the first body portion, the first extended portion having a dimension in the width direction smaller than a dimension of the first body portion in the width direction, the first extended portion being extended to the first end surface;
the first body portion includes:
a first non-connection-side end portion located on a side of the second end surface; and
a first connection-side end portion located on the side of the first end surface;
the second internal electrode includes:
a second body portion having a substantially rectangular shape or having a substantially rectangular shape with a cutout on the side of the second end surface; and
a second extended portion coupled to the second body portion, the second extended portion having a dimension in the width direction smaller than a dimension of the second body portion in the width direction, the second extended portion being extended to the second end surface;
the second body portion includes:
a second non-connection-side end portion located on the side of the first end surface; and
a second connection-side end portion located on the side of the second end surface;
the third internal electrode includes:
a third body portion having a substantially rectangular shape or having a substantially rectangular shape with a cutout on the side of the first end surface; and
a third extended portion coupled to the third body portion, the third extended portion having a dimension in the width direction smaller than a dimension of the third body portion in the width direction, the third extended portion being extended to the first end surface;
the third body portion includes:
a third non-connection-side end portion located on the side of the second end surface; and
a third connection-side end portion located on the side of the first end surface;
the fourth internal electrode includes:
a fourth body portion having a substantially rectangular shape or having a substantially rectangular shape with a cutout on the side of the second end surface; and
a fourth extended portion coupled to the fourth body portion, the fourth extended portion having a dimension in the width direction smaller than a dimension of the fourth body portion in the width direction, the fourth extended portion being extended to the second end surface;
the fourth body portion includes:
a fourth non-connection-side end portion located on the side of the first end surface; and
a fourth connection-side end portion located on the side of the second end surface; and
the first connection-side end portion and the third connection-side end portion do not overlap with each other in the lamination direction.

2. The multilayer ceramic capacitor according to claim 1, wherein the second connection-side end portion and the fourth connection-side end portion do not overlap with each other in the lamination direction.

3. The multilayer ceramic capacitor according to claim 1, wherein the first non-connection-side end portion and the third non-connection-side end portion do not overlap with each other in the lamination direction.

4. The multilayer ceramic capacitor according to claim 1, wherein the second non-connection-side end portion and the fourth non-connection-side end portion do not overlap with each other in the lamination direction.

5. The multilayer ceramic capacitor according to claim 1, wherein the first non-connection-side end portion, the second connection-side end portion, and the fourth connection-side end portion do not overlap with each other in the lamination direction.

6. The multilayer ceramic capacitor according to claim 1, wherein the second non-connection-side end portion, the first connection-side end portion, and the third connection-side end portion do not overlap with each other in the lamination direction.

7. The multilayer ceramic capacitor according to claim 1, wherein the third non-connection-side end portion, the second connection-side end portion, and the fourth connection-side end portion do not overlap with each other in the lamination direction.

8. The multilayer ceramic capacitor according to claim 1, wherein the fourth non-connection-side end portion, the first connection-side end portion, and the third connection-side end portion do not overlap with each other in the lamination direction.

9. The multilayer ceramic capacitor according to claim 1, wherein the first extended portion and the third extended portion have different dimensions in the length direction.

10. The multilayer ceramic capacitor according to claim 1, wherein the second extended portion and the fourth extended portion have different dimensions in the length direction.

11. The multilayer ceramic capacitor according to claim 3, wherein the first non-connection-side end portion, the second connection-side end portion, and the fourth connection-side end portion do not overlap with each other in the lamination direction.

12. The multilayer ceramic capacitor according to claim 3, wherein the second non-connection-side end portion, the first connection-side end portion, and the third connection-side end portion do not overlap with each other in the lamination direction.

13. The multilayer ceramic capacitor according to claim 3, wherein the third non-connection-side end portion, the second connection-side end portion, and the fourth connection-side end portion do not overlap with each other in the lamination direction.

14. The multilayer ceramic capacitor according to claim 3, wherein the fourth non-connection-side end portion, the first connection-side end portion, and the third connection-side end portion do not overlap with each other in the lamination direction.

15. The multilayer ceramic capacitor according to claim 2, wherein the second non-connection-side end portion and the fourth non-connection-side end portion do not overlap with each other in the lamination direction.

16. The multilayer ceramic capacitor according to claim 2, wherein the first non-connection-side end portion, the second connection-side end portion, and the fourth connection-side end portion do not overlap with each other in the lamination direction.

17. The multilayer ceramic capacitor according to claim 2, wherein the second non-connection-side end portion, the first connection-side end portion, and the third connection-side end portion do not overlap with each other in the lamination direction.

18. The multilayer ceramic capacitor according to claim 2, wherein the third non-connection-side end portion, the second connection-side end portion, and the fourth connection-side end portion do not overlap with each other in the lamination direction.

19. The multilayer ceramic capacitor according to claim 2, wherein the fourth non-connection-side end portion, the first connection-side end portion, and the third connection-side end portion do not overlap with each other in the lamination direction.
